(19) United States
(12) Patent Application Publication
(10) Pub. No.: US 2022/0315141 A1
(43) Pub. Date: Oct. 6, 2022

(54) AUXILIARY WHEEL FRAME STRUCTURE OF MOTORCYCLE

(71) Applicant: JING-LONG CHIU, Yilan County (TW)

(72) Inventor: JING-LONG CHIU, Yilan County (TW)

(21) Appl. No.: 17/656,920

(22) Filed: Mar. 29, 2022

(30) Foreign Application Priority Data
Mar. 31, 2021 (TW) 110112285

(51) Int. Cl. B62H 1/12

(52) U.S. Cl. CPC B62H 1/12; B62J 45/412

(57) ABSTRACT

The present invention provides an auxiliary wheel frame structure of motorcycle, which comprises a wheel frame, a block plate, and a wheel-frame controller. In the auxiliary wheel frame structure, the wheel-frame controller and the wheel frame are assembled to a chassis of a motorcycle. When the wheel-frame controller detects low-speed cruising of the motorcycle, the wheel-frame controller controls the wheel frame to descend. By using a first wheel and a second wheel of the wheel frame, the motorcycle still can be kept stable under low-speed cruising and hence improving riding safety for riders.

### FIELD OF THE INVENTION

The present invention relates generally to a structure, and particularly to an auxiliary wheel frame structure of motorcycle.

### BACKGROUND OF THE INVENTION

A traditional motorcycle is a motorized vehicle steers and turns according to the rider's center of gravity. Normally two- or three-wheeled, there are also single-, four-, or even no-wheeled designs. It is evolved from motorized bicycles. Two-wheeled motorcycles are the mainstream in the market and act as one of convenient vehicles.

There are various types of motorcycles in the market, mainly including foot-gearing motorcycles, lightweight motorcycles, scooters, and American motorcycles.

Some special-purpose motorcycles will include add-on auxiliary wheels, such as motorcycles for the disabled.

In some military or police applications, a side cabin and an auxiliary wheel will be added and becoming a special three-wheeled motorcycle. Presently, there are heavy motorcycles with three wheels for further stabilization at high speed.

Motorcycles own the features of easy control, convenience, and low price. Thereby, they are widely used in daily lives, transportation, surveillance, and military applications. In developing countries, motorcycles are also popular. Currently, there are approximately 200 million motorcycles worldwide, which translates to about 33 units per 1,000 people. Most motorcycles are adopted in Asia, occupying around 58% of the whole market (Japan not included).

Given the above features, motorcycles still have some drawbacks, including the number of motorcycles, the riding culture, impacts on the environment, and the safety problem.

1. The number of motorcycles: Most Asian countries develop and change rapidly in economy and income in a short time. Compared with cars, motorcycles are cheaper and hence making them more popular.

Take Taiwan's special case for example. Since the land is small and the population is dense, opening up more parking lots occupies more land. Considering ease of parking and convenience in usage, motorcycles become more prevailing in Taiwan.

Unfortunately, the prevalence of motorcycles usually leads to traffic jam and further resulting in increase in traffic accidents.

2. Riding culture: Some people use motorcycles to race on roads. They are called street racers. To pursue speed, their motorcycles are usually remodeled, including removing the muffler and making noises. Thereby, more social issues will arise.

3. Impacts on the environment: Thanks to their smaller size, lighter weight, and lower loading of engines, the engine temperature of motorcycles is easier to be controlled and thus the highly pollutive exhausts formed at high temperatures such as NOx are less. Nonetheless owing to lower usage costs, users tend to ignore maintenance and the pollution control system might fail, leading to pollution.

Moreover, the environment impacts are closely related to the number of motorcycles. Although the exhausts are fewer, given the huge number, tremendous impacts still occur on the environment. To solve the problem, the motorcycles in Taiwan are improved significantly.

Since 2004. Taiwan has modified the laws of environmental protection by raising the standard for exhausts by motorcycles. The motorcycles with two-stroke engines are carefully designed and manufactured, such as jet engines, to pass the 4th- or even the 5th-phase standard for environmental protection, the policy trend is still aiming at ending the sales of two-stroke motorcycles. Consequently, there is no new two-stroke motorcycles available in Taiwan. However, they are still exported continuously.

Since 2017, the KTM company announced a new-generation jet two-stroke engine. Their patented transfer port injection (TPI) jet system includes a novel throttle and an engine management system (EMS).

By using the new electronic control unit (ECU) along with multiple transducers, perfect ignition and jet oil supply can be achieved by computers. Consequently, the subsequently development of motorcycles still can adopt two-stroke engines and comply with the regulation requirements. The engines are used in their newly released off-road motorcycles and comply with the Euro 4 regulation.

4. The safety problem: This is problem frequently seen in the news. Compared to normal cars, motorcycles lack the protection of the car body. Thereby, they are less safe.

There is a frequent scenario. When a motorcycle cruises at low speed, the handlebar of the motorcycle will vibrate due to instability in the center of gravity. In addition to spontaneous crash or bump into people or vehicles on the roadside, the vibration might even cause the motorcycle to bump into the cars on the road. This safety problem is extremely dangerous and hence leading the improvement in the test to get the riding license.

To improve the above situation, in the license test, linear low-speed cruising is added for increasing a rider's technique as well as protecting passerby and the rider's safety. Nonetheless, the test can only filter new riders. As the riders get old, their riding stability get worse significantly, leading to more risks in riding.

Accordingly, how to prevent toppling down of motorcycles at low-speed cruising and avoid instable riding have become a major challenge in the field.

### SUMMARY

An objective of the present invention is to provide an auxiliary wheel frame structure of motorcycle. A wheel-frame controller and a wheel frame are assembled to a chassis of a motorcycle. When the wheel-frame controller detects low-speed cruising of the motorcycle, the wheel-frame controller controls the wheel frame to descend. By using wheels of the wheel frame, the motorcycle still can be kept stable under low-speed cruising and hence improving riding safety for riders.

To achieve to above objective, the present invention provides an auxiliary wheel frame structure of motorcycle fixed to a chassis of a motorcycle. The structure comprises a wheel frame, a block plate, and a wheel-frame controller. The wheel frame is disposed below the chassis with a first wheel and a second wheel on both sides. The block plate is disposed on one side of the wheel frame and against the wheel frame. The wheel-frame controller includes a rod, a sleeve, and a control device. One end of the rod is inserted into the sleeve; the other end of the rod is fixed on the block plate. One end of the sleeve is fixed to the motorcycle. The control device is disposed on one side of the sleeve. The control device of the wheel-frame controller detects a brake, a throttle, and a speedometer of the motorcycle. The wheel-frame controller controls ascending and descending of the wheel frame according to the brake, the throttle, and the speed reading of the speedometer.

According to an embodiment of the present invention, the wheel frame is rectangular, inverted U-shaped, or inverted V-shaped.

According to an embodiment of the present invention, the speed is 0-10 km/h.

According to an embodiment of the present invention, the wheel-frame controller controls the wheel frame to descend according to a deactivated state of the throttle, an activated state of the brake, and if the speed is lower than 10 km/h.

According to an embodiment of the present invention, the wheel-frame controller controls the wheel frame to ascend according to an activated state of the throttle and if the speed is higher than 10 km/h.

According to an embodiment of the present invention, the wheel-frame controller controls the wheel frame to ascend according to a deactivated state of the brake and if the speed is higher than 10 km/h.

### BRIEF DESCRIPTION OF THE DRAWINGS

FIG. 1A shows a structural schematic diagram of the auxiliary wheel frame of motorcycle according to an embodiment of the present invention:

FIG. 1B shows a structural schematic diagram of the wheel-frame controller according to an embodiment of the present invention;

FIG. 1C shows a schematic diagram of signal control by the control device according to an embodiment of the present invention;

FIG. 2A shows a schematic diagram of the usage state of the auxiliary wheel frame of motorcycle according to an embodiment of the present invention; and

FIG. 2B shows a schematic diagram of the usage state of the auxiliary wheel frame of motorcycle according to an embodiment of the present invention.

### DETAILED DESCRIPTION

While riding a motorcycle at low speed, the center of gravity of the motorcycle will be unstable and the handlebar will vibrate. Then the rider might crash spontaneously or bump into people or vehicles on the roadside, leading to extremely dangerous accidents.

The wheel-frame controller and the wheel frame according to the present invention are assembled to the chassis of a motorcycle. When the wheel-frame controller detects low-speed cruising of the motorcycle, the wheel-frame controller controls the wheel frame to descend. By using wheels of the wheel frame, the motorcycle still can be kept stable under low-speed cruising and hence improving riding safety for riders.

In the following description, various embodiments of the present invention are described using figures for describing the present invention in detail. Nonetheless, the concepts of the present invention can be embodied by various forms. Those embodiments are not used to limit the scope and range of the present invention.

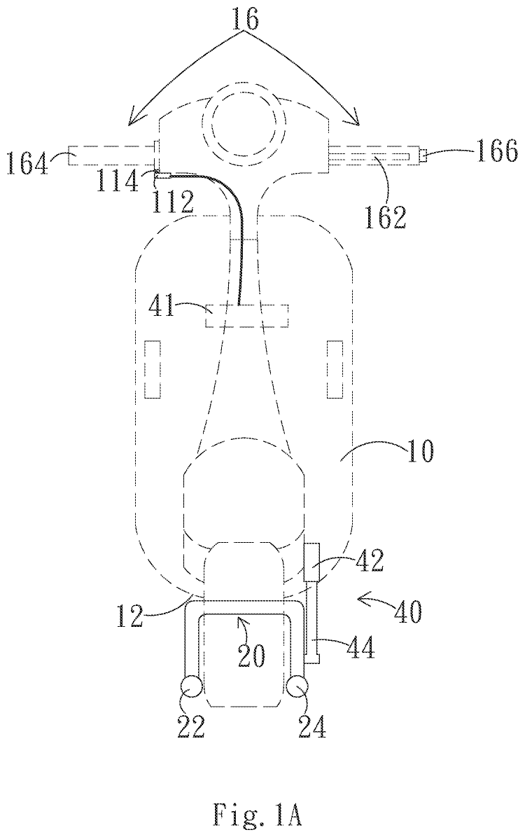

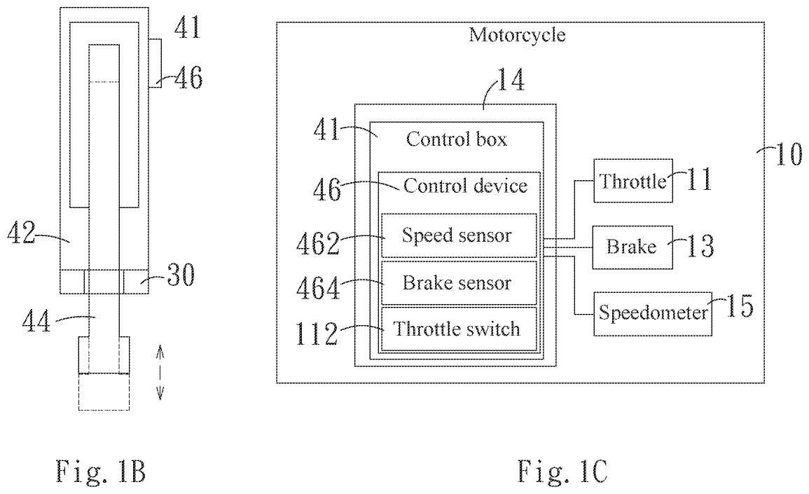

First, please refer to FIG. 1A, which shows a structural schematic diagram of the auxiliary wheel frame of motorcycle according to an embodiment of the present invention, and to FIG. 1B, which shows a structural schematic diagram of the wheel-frame controller according to an embodiment of the present invention. As shown in the figures, the auxiliary wheel frame structure of motorcycle according to the present invention is fixed to a chassis 12 of a motorcycle 10.

The auxiliary wheel frame structure according to the present invention comprises a wheel frame 20, a block plate 30, and a wheel-frame controller 40. The wheel frame 20 is disposed on one side of the chassis 12 with a first wheel 22 and a second wheel 24 on both sides. The block plate 30 is disposed on one side of the wheel frame 20 and against the wheel frame 20.

Please refer again to FIG. 1B. The wheel-frame controller 40 includes a rod 42, a sleeve 44, and a control device 46. One end of the rod 42 is inserted into the sleeve 44; the other end of the rod 42 is fixed on the block plate 30. One end of the sleeve 44 is fixed to the motorcycle 10. The control device 46 is disposed on one side of the sleeve 44.

The control device 46 is disposed in a control box 41. The control box 41 is disposed in an accommodation space 14 of the motorcycle 10. The wheel frame 20 can be rectangular, inverted U-shaped, or inverted V-shaped. Alternatively, the shape of the wheel frame 20 can be specially designed according to the shape of the chassis 12.

The hydraulic wheel-frame controller 40 is a common hydraulic rod according to the prior art. It converts hydraulic energy to mechanical energy for performing linear reciprocating or swing motions. A hydraulic rod is simple in structure and reliable. While implementing reciprocating motions using a hydraulic rod, no reducer is required and no transmission gap will occur, and hence resulting in stable motions. Thereby, hydraulic rods are extensively applied to the hydraulic system of various machines.

The main components of a hydraulic rod generally include a rear lid, a cylinder, a piston rod, and a front lid well known to a person having ordinary skill in the art. Hence, the details will not be described with figures. Furthermore, in a hydraulic rod, to avoid leakage of oil outside the hydraulic cylinder or from the high-pressure cylinder to the low-pressure cylinder, sealing components are disposed between the piston and the piston rod, the piston and the cylinder, and the piston rod and the front lid. An anti-dust component is also disposed outside the front lid. Besides, to avoid impact of the piston on the cylinder lid when the piston returns rapidly to the end of the stroke, a buffer component or an exhaust is further disposed at the end of the hydraulic cylinder for buffering.

Next, please refer to FIG. 1C, which shows a schematic diagram of signal control by the control device according to an embodiment of the present invention. As shown in the figure, the control device 46 of the wheel-frame controller 40 detects a brake 13, a throttle 11, and a speedometer 15 of the motorcycle 10. The wheel-frame controller 40 controls ascending and descending of the wheel frame 20 according to the brake 13, the throttle 11, and the speed reading of the speedometer 15.

In addition, the wheel-frame controller 40 is connected electrically to the existing brake device (the brake 13), the throttle structure (the throttle 11), and the speedometer (the speedometer 15) of the motorcycle 10. The wheel-frame controller 40 can detect digitally or analogically and acquire signals from the brake device (the brake 13), the throttle structure (the throttle 11), and the speedometer (the speedometer 15).

Furthermore, the wheel-frame controller 40 is connected to a speed sensor 462 or a positioning device (not shown in the figure) for detecting a wheel speed of the motorcycle 10 and generating a speed sensing signal corresponding to the speed to the control device 46. The control device 46 judges if the corresponding speed of the motorcycle 10 is smaller than 10 km/h according to the speed sensing signal. The positioning device adopts the global positioning system (GPS) in a mobile device.

The wheel-frame controller 40 is connected to a brake sensor 464. The brake sensor 464 detects a tensile force of a corresponding brake handle 162 of a handlebar set 16 for generating a brake signal corresponding to the brake state to the control device 46. The control device 46 judges the brake state according to the brake signal to be an activated state or a deactivated state. In other words, according to the above method of sensing brake, the wheel-frame controller 40 is connected electrically to the existing brake lamp signal of the motorcycle 10 for generating the brake signal corresponding to the brake state to the control device 46. The control device 46 judges the brake state to be the activated state or the deactivated state according to the brake signal.

The wheel-frame controller 40 is connected electrically to a throttle switch 112. The throttle switch 112 is disposed on one side of a throttle handle 164 of a handlebar set 16. The throttle handle 164 includes a projective member 114. The rotation of the throttle handle 164 enables the projective member 114 to contact or move away from the throttle switch 112. Then the throttle switch 112 can generate a switch signal corresponding to the throttle state to the control device 46 for judging the throttle state to be an activated state or a deactivated state.

The wheel-frame controller 40 controls the wheel frame 20 to descend according to a deactivated state of the throttle 11, an activated state of the brake 13, and if the speed is lower than 10 km/h. On the other hand, the wheel-frame controller 40 controls the wheel frame 20 to ascend according to an activated state of the throttle 11 and if the speed is higher than 10 km/h. Alternatively, the wheel-frame controller 40 controls the wheel frame 20 to ascend according to a deactivated state of the brake 13 and if the speed is higher than 10 km/h.

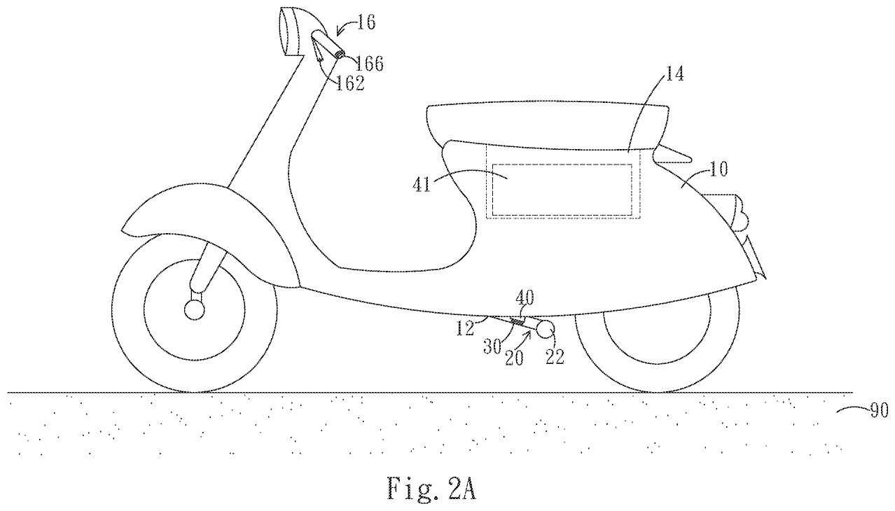

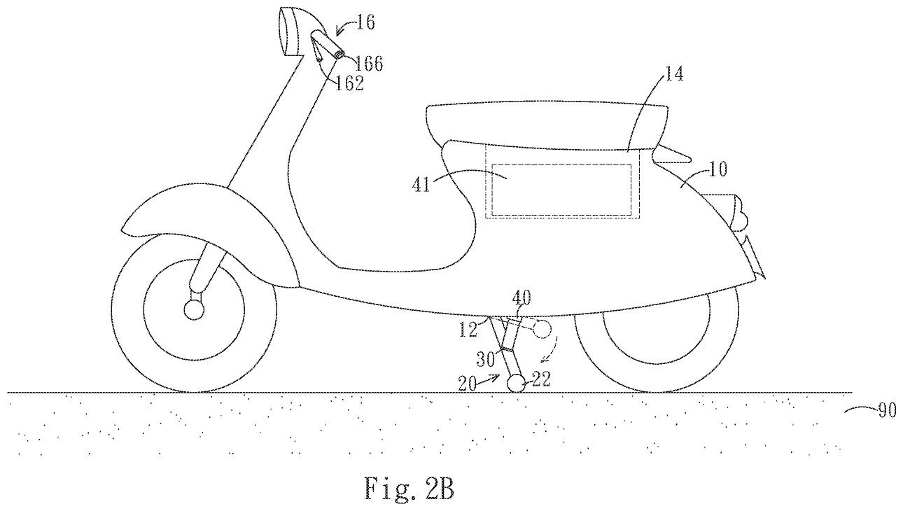

For example, please refer to FIG. 2A, which shows a schematic diagram of the usage state of the auxiliary wheel frame of motorcycle according to an embodiment of the present invention, and to FIG. 2B, which shows a schematic diagram of the usage state of the auxiliary wheel frame of motorcycle according to an embodiment of the present invention. As shown in the figures, when the motorcycle 10 decelerates and cruises at low speed, the throttle 11 of the motorcycle 10 is in a deactivated state and the brake 13 is in an activated state. Meanwhile, the speed of the motorcycle 10 is below 10 km/h. Then the wheel-frame controller 40 will drive the wheel frame 20 to descend such that the first wheel 22 and the second wheel 24 can touch the ground for auxiliary sliding. Thereby, the motorcycle 10 can be stabilized at low-speed cruising.

Furthermore, when the motorcycle 10 ends low-speed cruising but starts to accelerate, if the throttle 11 of the motorcycle is in an activated state and the speed is higher than 10 km/h, or if the brake 13 is in a deactivated state and the speed is higher than 10 km/h, the wheel-frame controller 40 will drive the wheel frame 20 to ascend, making the first wheel 22 and the second wheel 24 to leave the ground. Then the motorcycle 10 will resume to normal riding status.

Please refer again to FIGS. 2A and 2B. According to another embodiment of the present invention, in addition to controlling the wheel-frame controller 40 for ascending and descending using the control device 46 in the control box 41, the wheel-frame controller 40 can be operated manually using an ascending and descending button 166 disposed on one side of a handlebar set 16 of the motorcycle 10 for improving riders' riding safety on roads.

The advantage of the present invention is reducing the risks under low-speed cruising. At low-speed cruising, for example, the handlebar might vibrate. Besides, the rider is prone to crashes due to uneven road surfaces. By using the auxiliary wheels, riders' safety can be guaranteed. For elderly riders, the safety can be further improved. The traffic risks can be reduced substantially.

Accordingly, the present invention provides an auxiliary wheel frame structure of motorcycle. The wheel-frame controller and the wheel frame are assembled to the chassis of a motorcycle. When the wheel-frame controller detects low-speed cruising of the motorcycle, it will control the wheel frame to descend. By using the wheels on the wheel frame, the motorcycle can be kept stable at low-speed cruising and hence improving riders' safety.

What is claimed is:

1. An auxiliary wheel frame structure of motorcycle, fixed below a chassis of a motorcycle, comprising:
a wheel-frame controller, including a sleeve, a rod, a driving motor, and a control device, one of said sleeve fixed below said chassis, one of said rod sliding inside said sleeve, said control device disposed on one side of said sleeve, said driving motor disposed on the other side of said sleeve, and said control device connected electrically to said driving motor; and
a wheel frame, disposed pivotally below said chassis, one end of said wheel frame disposed pivotally on the other end of said rod, and including a first wheel and a second wheel on both sides;
where said control device detects a brake, a throttle, and a speedometer of said motorcycle; said control device controls said driving motor according to a brake state of said brake, a throttle state of said throttle, and a speed reading of said speedometer; and said driving motor drives said rod to move and rod drives said wheel frame to ascend or descend.

2. The wheel frame structure of motorcycle of claim 1, wherein said wheel frame is rectangular, inverted U-shaped, or inverted V-shaped.

3. The wheel frame structure of motorcycle of claim 1, wherein said wheel-frame controller is connected to a speed sensor or a positioning device for detecting a wheel speed of said motorcycle and generating a speed sensing signal corresponding to said speed to said control device; and said control device judges if the corresponding speed of said motorcycle is less than 10 km/h according to said speed sensing signal.

4. The wheel frame structure of motorcycle of claim 1, wherein said wheel-frame controller is connected to a brake sensor; said brake sensor detects a tensile force of a corresponding brake handle of a handlebar set for generating a brake signal corresponding to the brake state to the control device; and said control device judges said brake state according to said brake signal to be an activated state or a deactivated state.

5. The wheel frame structure of motorcycle of claim 1, wherein said wheel-frame controller is connected electrically to a throttle switch; said throttle switch is disposed on one side of a throttle handle of a handlebar set; said throttle handle includes a projective member; the rotation of said throttle handle enables said projective member to contact or move away from said throttle switch; then said throttle switch generates a switch signal corresponding to said throttle state to said control device for judging said throttle state to be an activated state or a deactivated state.

6. The wheel frame structure of motorcycle of claim 1, wherein said control device controls said wheel frame to descend according to a deactivated state of said throttle stat, an activated state of said brake state, and if said speed is lower than 10 km/h.

7. The wheel frame structure of motorcycle of claim 1, wherein said control device controls said wheel frame to ascend according to an activated state of said throttle state and if said speed is higher than 10 km/h.

8. The wheel frame structure of motorcycle of claim 1, wherein said control device controls said wheel frame to ascend according to a deactivated state of said brake state and if said speed is higher than 10 km/h.

9. The wheel frame structure of motorcycle of claim 1, and further comprising an ascending and descending button disposed on one side of a handlebar set of said motorcycle for ascending or descending said wheel frame.

10. The wheel frame structure of motorcycle of claim 1, wherein said control device is disposed in a control box; and said control box is disposed in an accommodating space of said motorcycle.
